(19) United States
(12) Patent Application Publication
(10) Pub. No.: US 2014/0372041 A1
(43) Pub. Date: Dec. 18, 2014

(54) VALIDATION OF PHYSICAL AND MECHANICAL ROCK PROPERTIES FOR GEOMECHANICAL ANALYSIS

(71) Applicants: Umesh Prasad, Houston, TX (US); Javier A. Franquet, Houston, TX (US); David Curry, London (GB)

(72) Inventors: Umesh Prasad, Houston, TX (US); Javier A. Franquet, Houston, TX (US); David Curry, London (GB)

(73) Assignee: BAKER HUGHES INCORPORATED, Houston, TX (US)

(21) Appl. No.: 13/918,044

(22) Filed: Jun. 14, 2013

(51) Int. Cl. G01V 99/00

(52) U.S. Cl. CPC G01V 99/005
USPC 702/11

(57) ABSTRACT

A method for validating earth formation data for input into a geophysical model includes: determining a lithology of the earth formation; receiving measurement data for a plurality of different properties of the earth formation rock; plotting data points for a first property versus a second property in a cross-plot using the received measurement data; plotting an expected correlation between the first property and the second property on the cross-plot for rock of the determined lithology; establishing an acceptance criterion for validating the data points related to the first property and the second property with respect to the expected correlation; determining which of the plotted data points fall within the acceptance criterion to provide validated data points related to the first property and the second property; and inputting the validated data points related to the first property and the second property into the geomechanical model.

### BACKGROUND

Geomechanical models are used to model earth formations for the purpose of exploration and production of hydrocarbons. These models typically use several inputs of physical and mechanical rock properties in order to model the earth formations to determine a parameter of interest such as borehole stability for example. Unfortunately, there may be a dearth of data for a particular formation or an abundance of data some of which may conflict with other data. Accurate data is needed to produce accurate results from the geomechanical model. It would be well received in the drilling and geophysical exploration industries if a method for validating data for use in geomechanical models could be developed.

### BRIEF SUMMARY

Disclosed is a method for validating earth formation data for input into a geophysical model. The method includes: determining a lithology of the earth formation; receiving measurement data for a plurality of different properties of the earth formation rock using a processor; plotting data points for a first property versus a second property in a cross-plot, the data points for the first property and the second property being selected from the received measurement data using the processor; plotting an expected correlation between the first property and the second property on the cross-plot for rock of the determined lithology using the processor; establishing an acceptance criterion for validating the data points related to the first property and the second property with respect to the expected correlation; determining which of the plotted data points related to the first property and the second property fall within the acceptance criterion to provide validated data points related to the first property and the second property using the processor; and inputting the validated data points related to the first property and the second property into the geomechanical model using the processor.

Also disclosed is a non-transitory computer-readable medium having computer-executable instructions for validating earth formation data for input into a geophysical model by implementing a method. The method includes: receiving measurement data for a plurality of different properties of the earth formation rock; determining a lithology of the earth formation using the received measurement data; plotting data points for a first property versus a second property in a cross-plot, the data points for the first property and the second property being selected from the received measurement data; plotting an expected correlation between the first property and the second property on the cross-plot for rock of the determined lithology; establishing an acceptance criterion for validating the data points related to the first property and the second property with respect to the expected correlation; and determining which of the plotted data points related to the first property and the second property fall within the acceptance criterion to provide validated data points related to the first property and the second property.

### BRIEF DESCRIPTION OF THE DRAWINGS

The following descriptions should not be considered limiting in any way. With reference to the accompanying drawings, like elements are numbered alike:

FIG. 1 illustrates a cross-sectional view of an exemplary embodiment of a downhole tool disposed in a borehole penetrating the earth;

FIG. 2 is a flow chart for a method for validating earth formation data for input into a geophysical model;

FIG. 3 is one example of a cross-plot of unconstrained or unconfined compressive strength, UCS, versus porosity for sandstone;

FIG. 4 illustrates one example of UCS cross-plotted against DTC for sandstone formation rock;

FIG. 5 illustrates one example of USC cross-plotted against EMOD for sandstone formation rock;

FIG. 6 illustrates one example of friction angle cross-plotted against porosity for sandstone formation rock;

FIG. 7 illustrates one example of UCS cross-plotted against porosity for limestone formation rock; and

FIG. 8 illustrates one example of UCS cross-plotted against porosity for shale formation rock.

### DETAILED DESCRIPTION

A detailed description of one or more embodiments of the disclosed apparatus and method presented herein by way of exemplification and not limitation with reference to the figures.

Disclosed are methods for validating data to be input into a geomechanical model of an earth formation. The term “geomechanical model” relates to one or more mathematical equations relating one or more properties of the rock in the earth formation to one or more parameters of interest such as borehole stability or the ability of the formation to produce hydrocarbons. Geomechanical models are useful in before, during and after drilling operations such as wellbore stability studies, sand production and compaction estimation, and perforation and fracture design. Altogether, the various geomechanical models may cover the whole life period of oil and gas production processes. In that various geomechanical models are known in the art, they are not discussed in further detail.

Data validation includes determining a lithology type for the formation rock of interest. Data of at least two or more different properties are plotted as cross-plots. An expected relationship between the two different properties of the cross-plot based on the determined lithology type is also plotted on the cross-plot. Data that deviates from the expected relationship by exceeding an acceptance criterion is labeled not-validated and is excluded from being input into the geomechanical model. Non-validated data may be reviewed in further detail to determine a reason that this data exceeded the acceptance criteria.

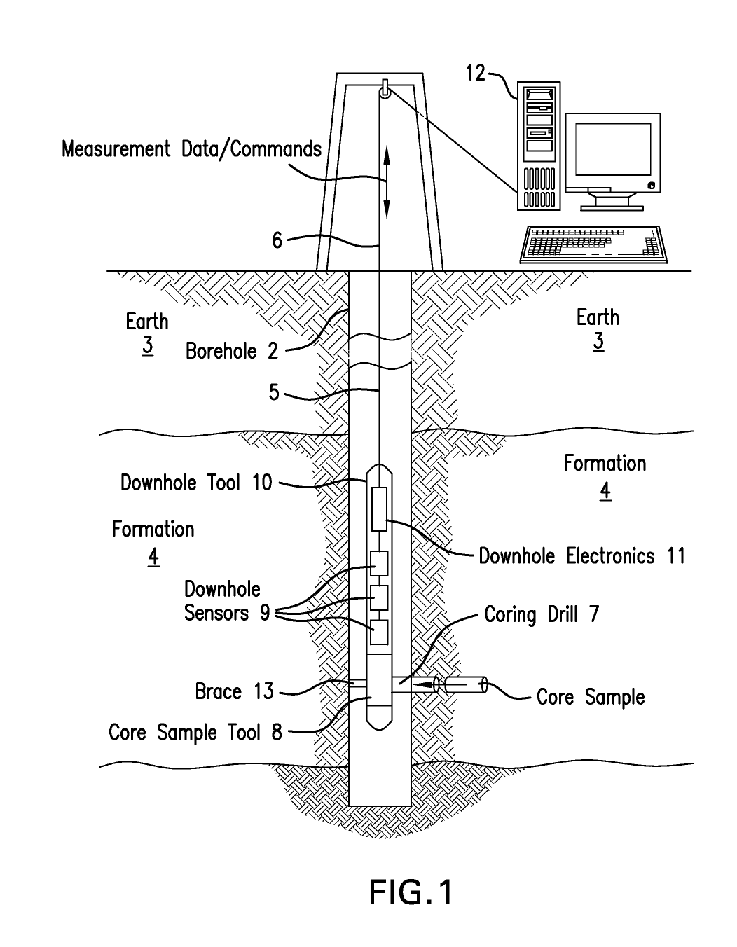

FIG. 1 illustrates a cross-sectional view of an exemplary embodiment of a downhole tool 10 disposed in a borehole 2 penetrating the earth 3. The earth 3 includes an earth formation 4 having formation rock of one or more particular lithologies. The downhole tool 10 includes one or more sensors 9 that are configured to sense or measure one or more formation rock properties of interest that may be input into a geomechanical model. Non-limiting embodiments of the formation rock properties include density, porosity and sound speed. Other properties may be sensed by the sensors 9 in support of determining the formation rock properties of interest. These other properties include formation pressure, formation temperature, and radiation emitted by the formation rock, which may be correlated to rock composition. In addition to the sensors 9, the downhole tool 10 includes a core sample tool 8. The core sample tool 8 includes an extendable coring drill 7 that is configured to drill into the borehole wall and extract a sample of formation rock into a hollow portion of the drill 7. Core samples of formation rock are stored in the core sample tool 8 and retrieved at the surface of the earth when the downhole tool 10 is removed from the borehole 2. The rock samples are analyzed in a laboratory to determine formation rock properties that may include Mohr-friction angle, various types of rock strength including unconstrained compressive strength, fluid content, composition (including cementation or impurities), and properties that may have already been measured the sensors 9. An extendable brace 13 is configured to brace the core sample tool 8 against the borehole wall while a core sample is being extracted.

Downhole electronics 11 are configured to operate the downhole tool 10, process measurement data obtained downhole, and/or act as an interface with telemetry to communicate data or commands between downhole components and a computer processing system 12 disposed at the surface of the earth 3. System operation, data processing and/or control functions may be performed the downhole electronics 11, the computer processing system 12, or by a combination thereof.

A carrier 5 is configured to convey the downhole tool 10 through the borehole 2. In the embodiment of FIG. 1, the carrier 5 is an armored wireline 6. The wireline 6 may include one or more conductors for providing telemetry to the surface. In an alternative embodiment, the carrier 5 may be a drill string in an embodiment referred to a logging-while-drilling (LWD). In LWD, measurements may be performed while the borehole 2 is being drilled or during a temporary halt in drilling. Telemetry in non-limiting LWD embodiments may include pulsed-mud and wired drill pipe.

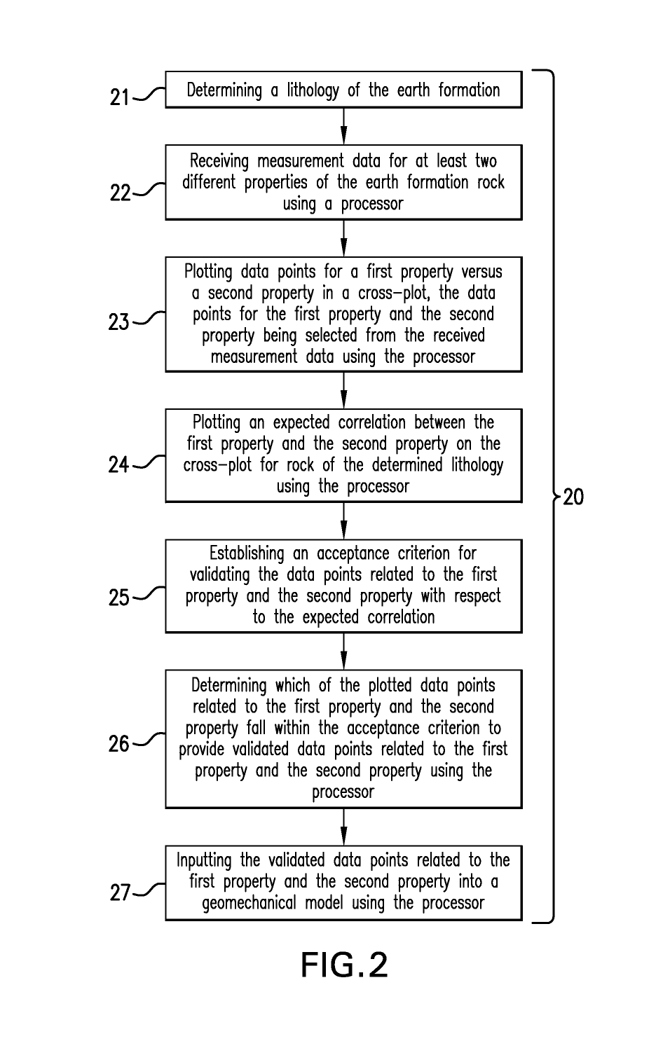

FIG. 2 is a flow chart for a method 20 for validating earth formation data for input into a geophysical model. Block 21 calls for determining a lithology of the earth formation. Non-limiting embodiments of lithology categories include sandstone, limestone, and shale. The lithology may be determined from downhole measurements or from sample analysis is a laboratory. In one or more embodiments, the core sample may be visually compared to known samples. In one or more embodiments an X-ray diffraction analysis may be performed on a core sample. Similarly, a downhole image of formation rock (visual or property image) may be compared to images of rock of known lithology. In one or more embodiments, the lithology is determined by a processor using formation rock measurement data input into the processor. Alternatively, the lithology may already have been determined and the pre-determined lithology may then be input into the processor. This block may also include extraction of the core sample using the core sample tool 8, core sample analysis, or performing formation rock measurements using one or more of the sensors 9 to provide data for determining the lithology of the formation rock of interest.

Block 22 calls for receiving measurement data for at least two different properties of the earth formation rock using a processor such as in the computer processing system 12. Non-limiting embodiments of the properties include unconstrained (or unconfined) compressive strength (UCS), density, porosity, Mohr-friction angle, compressional wave travel time (DTC), shear wave travel time (DTS), and Young's modulus of elasticity (EMOD). UCS represents the maximum stress sustained in an unconfined uni-axial loading condition beyond which load carrying capacity decreases drastically until physical disconnection between fractured pieces occurs. Further, since the amount of strain sustained in compressive loading is about 0.2-0.5%, the slope of the line of the stress-strain curve (EMOD) is also proportional to the UCS. The EMOD together with the shear modulus dictate compressional and shear wave velocity (units of distance/time or its inverse time/distance as in DTC and DTS).Both DTC and DTS are usually measured in a borehole environment regularly and a correlation generally exists between UCS and DTC and between UCS and DTS. UCS is usually measured under an in-situ confining pressure condition and is extrapolated to an unconfined condition. The confined compressive strength (CCS), in general, increases linearly with effective confining pressure (confining pressure minus pore pressure). This linear slope is termed Mohr-failure friction angle. The Mohr-failure friction angle together with UCS can be used to calculate CCS. UCS is a fundamental measurement value in that it not only represents strength of a rock type but also represents stiffness and/or elastic behavior, which are key parameters in details of borehole design and oil and gas production processes. This block may also include extraction of the core sample using the core sample tool 8, core sample analysis, or performing formation rock measurements using one or more of the sensors 9 to provide data for the two or more different properties that are to be cross-plotted.

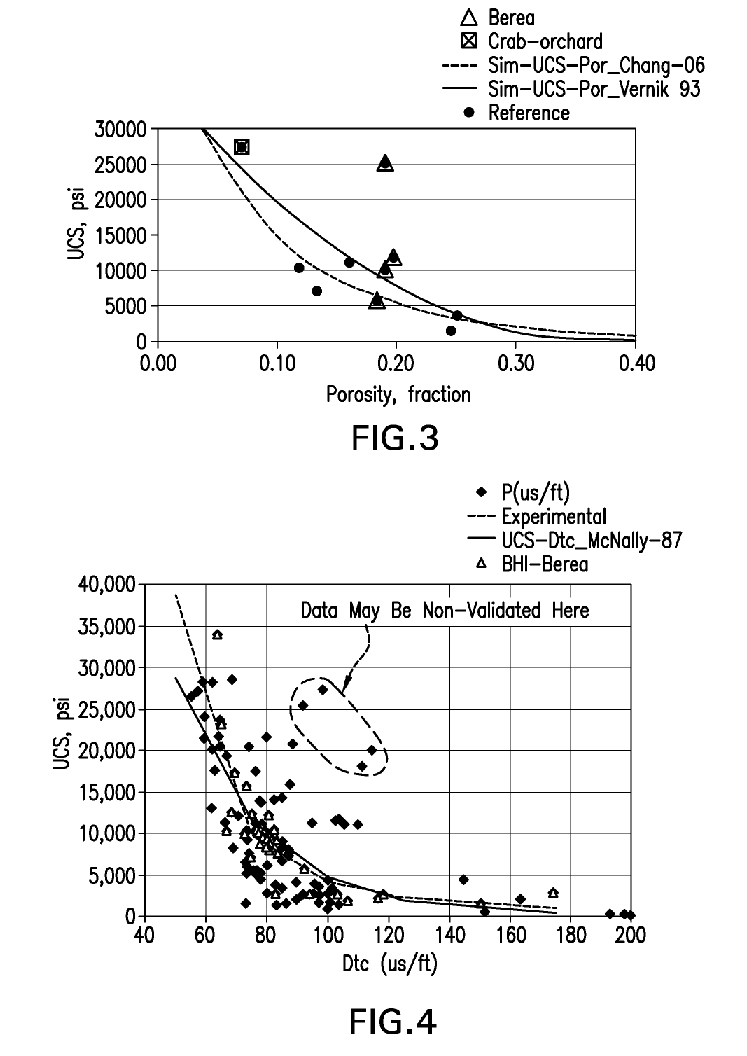

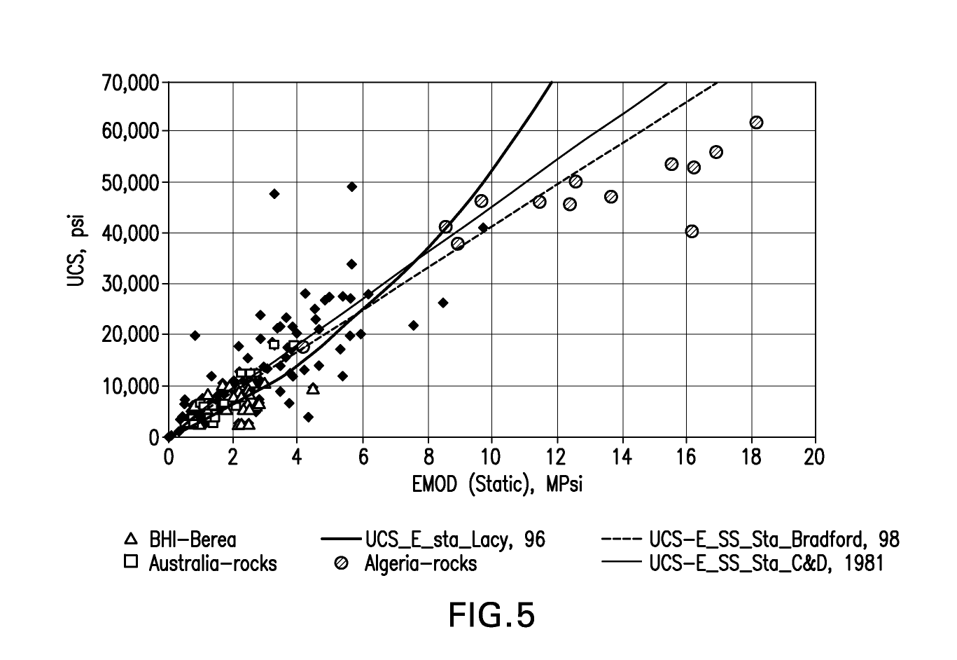

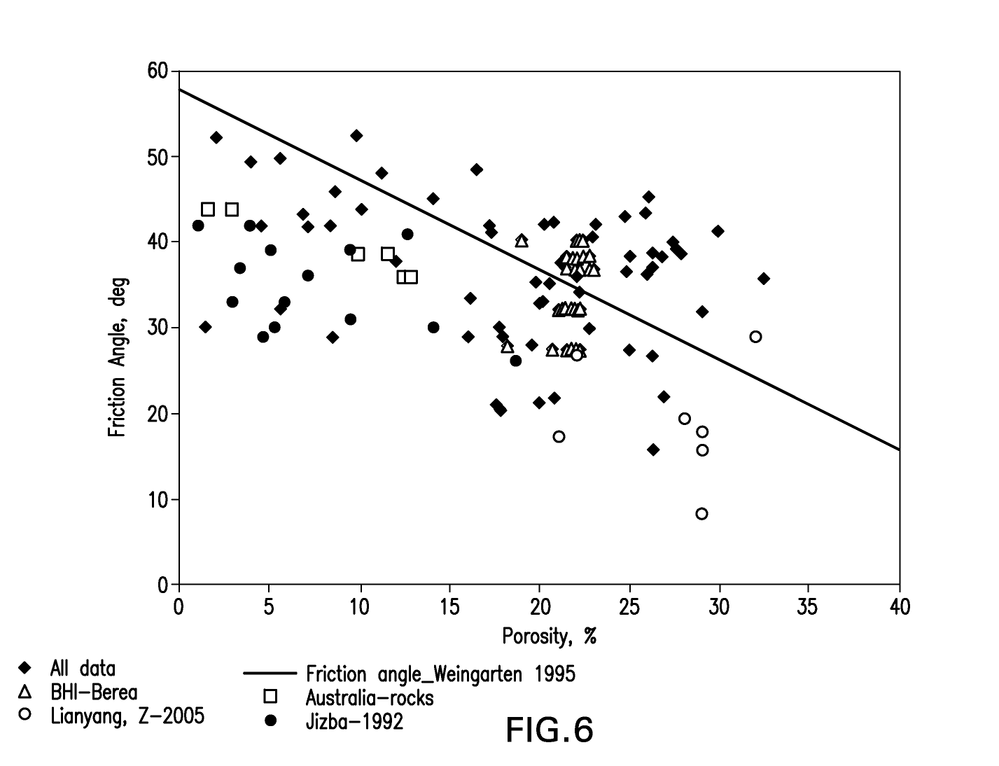

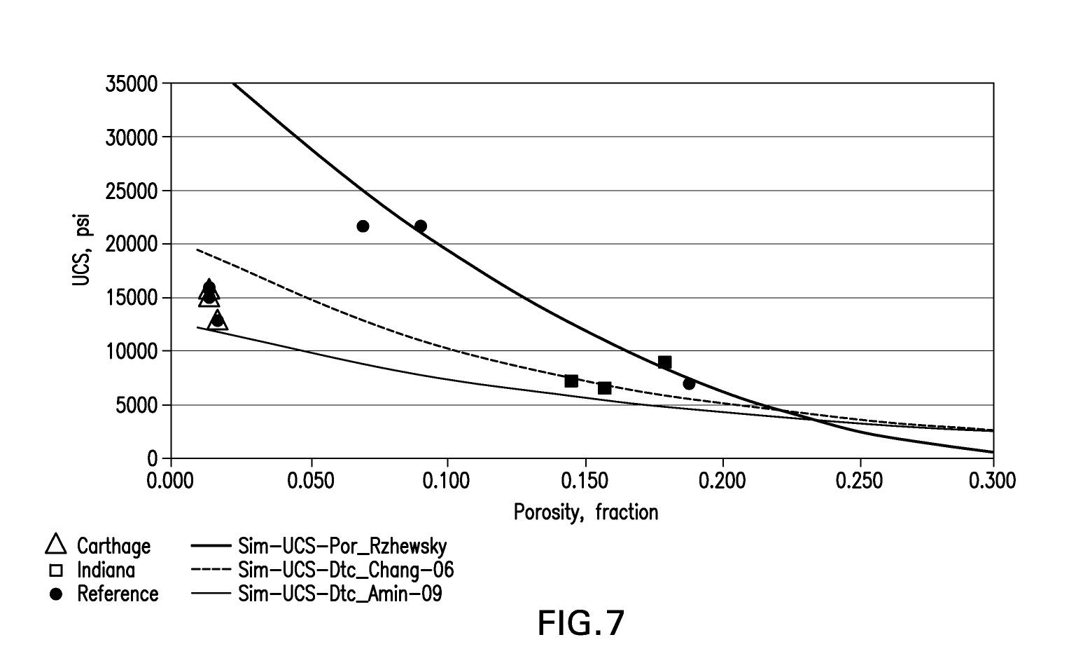

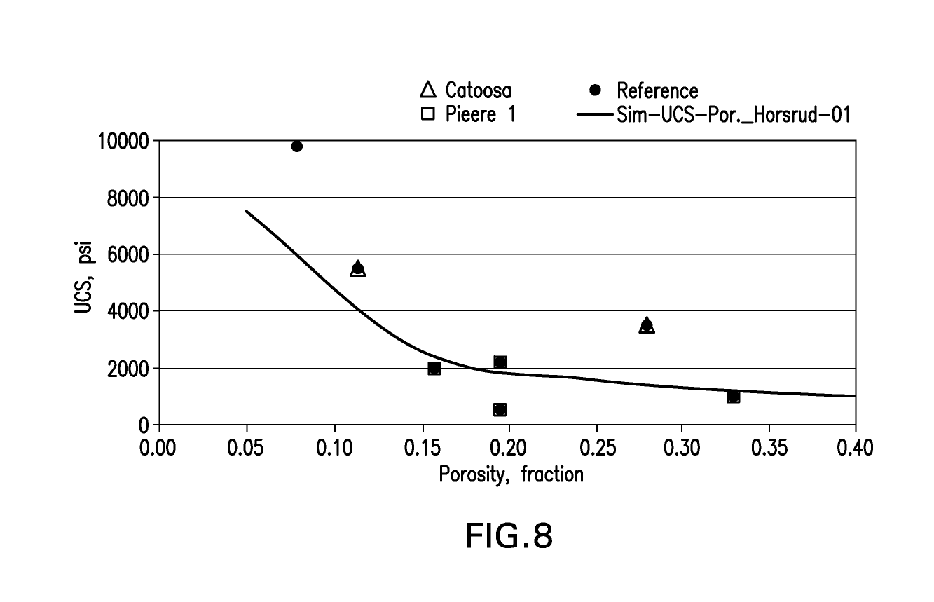

Block 23 calls for plotting data points for one selected property versus another selected property in a cross-plot. FIG. 3 illustrates one example of UCS cross-plotted against porosity for sandstone formation rock. FIG. 4 illustrates one example of UCS cross-plotted against DTC for sandstone formation rock. FIG. 5 illustrates one example of UCS cross-plotted against EMOD for sandstone formation rock. FIG. 6 illustrates one example of friction angle cross-plotted against porosity for sandstone formation rock. FIG. 7 illustrates one example of UCS cross-plotted against porosity for limestone formation rock. FIG. 8 illustrates one example of UCS cross-plotted against porosity for shale formation rock.

Block 24 calls for plotting an expected correlation between the two selected properties on the cross-plot for rock of the lithology determined in block 21. The expected correlation for a type of rock can be a correlation (i.e., empirical equation) known in the art or it can be a correlation determined by experimentation on various rock types of interest that may be encountered while drilling a specific formation. In FIG. 3, expected correlations known in art and referred to as Chang '06 and Vernik '93 are plotted. In FIG. 4, the expected correlation known in the art and referred to as McNally '87 and an experimentally determined correlation are plotted. In FIG. 5, expected correlations known in the art and referred to as Lacy '96, Bradford '98, and C&D 1981 are plotted. In FIG. 6, the expected correlation known in the art and referred to as Weingarten 1995 is plotted. In FIG. 7, expected correlations known in the art and referred to as Rzhewsky, Chang '06, and Amin '09 are plotted. In FIG. 8, the expected correlation known in the art and referred to as Horsrud '01 is plotted. Another well-known empirical equation for shale rock is Laskaripout-Dussault.

Block 25 calls for establishing an acceptance criterion for validating data with respect to the expected correlation. It can be appreciated that the “establishing” can inherently include receiving a pre-established acceptance criterion. In one or more embodiments, the acceptance criterion is selected to be an acceptance band about the plotted expected correlation. The width of the acceptance band may be a selected percentage of the expected correlation such as +/−5, 10, 15, 20, 25, . . . etc. % of the expected correlation as non-limiting embodiments. It can be appreciated that a tension may exist between the width of the acceptance band and the amount of data available to be input into the geomechanical model. A narrow acceptance band may exclude a significant amount of data that may be input into the geomechanical model and, thus, limit the value of the model. Conversely, a wide acceptance band may validate a large amount of data that is input into the geomechanical model, but the output of the model may be less accurate because of the wide scatter of data. Hence, in one or more embodiments, the width of the acceptance band is selected to validate at least a minimum amount of data that would provide useful output from the geomechanical model. The minimum amount of data in one or more embodiments is data that spans a selected depth interval of the formation. It can be appreciated that other techniques may be employed to establish an acceptance criterion. These other techniques may include statistical methods, some of which may be implemented by a commercially available software package, that calculate of the scatter of data from the expected correlation. In one or more embodiments, for each data point a difference from the expected correlation for one or more properties is calculated and a mean of the differences is then determined. From the mean and the differences, one or more standard deviations from the mean are calculated. Then, an acceptance criterion can be established as a fraction or multiple of the standard deviation from the mean or from the expected correlation.

Block 26 calls for determining which of the plotted data points falls within the acceptance criterion with respect to the expected correlation to provide validated data. FIG. 6 illustrates some data points that may fall outside of the acceptance criterion depending on the acceptance band. Block 27 calls for inputting the validated data into the geomechanical model.

It can be appreciated that non-validated data may warrant further review. Data may be non-validated due to an improper measurement or testing. Hence, in one or more embodiments, the measurement or testing is redone and the new data is evaluated with respect to the acceptance criterion. If the new data is validated, then it is also input into the geomechanical model. Alternatively, new or different tests may be performed such as an X-ray diffraction test on a core sample. The X-ray diffraction test may warrant categorizing the formation rock of interest as a different rock type and, thus, having a different expected data correlation. In another situation, data may be non-validated for other reasons such as the formation rock containing impurities such as other minerals as determined by further testing such as X-ray diffraction testing. In these situations, the formation rock may be re-categorized to take into account the quantity of impurities. In other situations, the depth of the core sample with respect to logged data may be reviewed to determine if there is an error in calibration of the depth of the sample and the depths of the logged data. If there is a calibration error, correct logged data for a property may be correlated to a different property determined from the sample, thus providing a new cross-plot in which some or all of the new cross-plot data is validated. In summary, non-validated data may be not used for input into a geomechanical model, may be reviewed with further testing and re-categorized and re-cross-plotted using a different expected correlation, or may be reviewed to recalibrate the depth of the core sample with the depth of logged data used to provide a correct cross-plot property that is then cross-plotted against the data determined from the core sample. Other options for handling non-validated data are also possible depending on the further tests and/or reviews.

It can be appreciated that further quality checks on measurement data obtained from laboratory analysis of core samples may be performed. These quality checks involve comparing the measurement data to known properties of the rock type and specific minerals for the formation rock of interest. If values of the measurement data exceeds (or falls short of) a known property value, then the measurement data is labeled as suspect requiring further review and/or validation of the measurements performed. For example, if the formation rock of interest is sandstone made up of predominantly the mineral quartz having a density of 2.65 gm/cc, then a density measurement of that rock is expected to be about the same. If the value of the density measurement is not that value, then the density measurement data is suspect and the sandstone composition and/or the measurement procedure requires checking before the data is used. As another example, limestone made up predominantly of calcite is expected to have a density of 2.72 gm/cc, which is the density of calcite. Density measurement values that differ are suspect warranting further review. Other known properties, such as DTC, DTS, or EMOD, may also be used for comparison in the quality checks. In one or more embodiments, the acceptance criterion for thus type of quality check is plus or minus a selected percentage of the known property value such as +/−5%. Test data that falls within the acceptance criterion may be used for plotting data points in the cross-plots.

One advantage of the methods disclosed herein is that formation rock data may be available from different sources that may not be aware of each other. The disclosed methods provide for obtaining data from these sources and applying a validation procedure to accept data that may be input into a geomechanical model and having confidence that the model will produce useful outputs.

It can be appreciated that the cross-plots disclosed herein may be plotted “virtually” within a computer processor without actually producing a printed or displayed plot or graph. It is intended that the terms “plotting,” “cross-plotting,” and the like inherently include the virtual aspect of these terms.

In support of the teachings herein, various analysis components may be used, including a digital and/or an analog system. For example, the downhole tool 10, the sensors 9, the downhole electronics 11, or the computer processing system 12 may include digital and/or analog systems. The system may have components such as a processor, storage media, memory, input, output, communications link (wired, wireless, pulsed mud, optical or other), user interfaces, software programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a non-transitory computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

The term “carrier” as used herein means any device, device component, combination of devices, media and/or member that may be used to convey, house, support or otherwise facilitate the use of another device, device component, combination of devices, media and/or member. Other exemplary non-limiting carriers include drill strings of the coiled tube type, of the jointed pipe type and any combination or portion thereof. Other carrier examples include casing pipes, wirelines, wireline sondes, slickline sondes, drop shots, bottom-hole-assemblies, drill string inserts, modules, internal housings and substrate portions thereof.

Elements of the embodiments have been introduced with either the articles “a” or “an.” The articles are intended to mean that there are one or more of the elements. The terms “including” and “having” are intended to be inclusive such that there may be additional elements other than the elements listed. The conjunction “or” when used with a list of at least two terms is intended to mean any term or combination of terms. The terms “first,” “second” and the like do not denote a particular order, but are used to distinguish different elements.

While one or more embodiments have been shown and described, modifications and substitutions may be made thereto without departing from the spirit and scope of the invention. Accordingly, it is to be understood that the present invention has been described by way of illustrations and not limitation.

It will be recognized that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood that various changes may be made and equivalents may be substituted for elements thereof without departing from the scope of the invention. In addition, many modifications will be appreciated to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for validating earth formation data for input into a geophysical model, the method comprising:
determining a lithology of the earth formation;
receiving measurement data for a plurality of different properties of the earth formation rock using a processor;
plotting data points for a first property versus a second property in a cross-plot, the data points for the first property and the second property being selected from the received measurement data using the processor;
plotting an expected correlation between the first property and the second property on the cross-plot for rock of the determined lithology using the processor;
establishing an acceptance criterion for validating the data points related to the first property and the second property with respect to the expected correlation;
determining which of the plotted data points related to the first property and the second property fall within the acceptance criterion to provide validated data points related to the first property and the second property using the processor; and
inputting the validated data points related to the first property and the second property into the geomechanical model using the processor.

2. The method according to claim 1, further comprising:
plotting data points for a first property versus a third property in a cross-plot, the data points for the first property and the second property being selected from the received measurement data; and
plotting an expected correlation between the first property and the third property on the cross-plot for rock of the determined lithology;
establishing an acceptance criterion for validating the data points related to the first property and the third property with respect to the expected correlation;
determining which of the plotted data falls related to the first property and the third property fall within the acceptance criterion to provide validated data related to the first property and the third property; and
inputting the validated data points related to the first property and the third property into the geomechanical model.

3. The method according to claim 1, wherein the plurality of different properties comprises at least two selections from a group consisting of unconstrained compressive strength, porosity, density, Mohr-friction angle, compressional wave travel time, shear wave travel time , and Young's modulus of elasticity.

4. The method according to claim 1, further comprising conveying a downhole sensor through a borehole penetrating the earth formation and performing measurements of one or more properties of the earth formation.

5. The method according to claim 4, further comprising:
conveying a core sample tool through a borehole penetrating the earth formation;
extracting a core sample from the earth formation using the core sample tool;
measuring a depth in the formation at which the core sample was obtained; and
performing one or more tests on the core sample to determine one or more properties of the earth formation.

6. The method according to claim 5, wherein the test comprises an X-ray diffraction test configured to determine a composition of the earth formation.

7. The method according to claim 5, further comprising correlating the depth at which the core sample was extracted to the depth at which measurements were performed by the downhole sensor.

8. The method according to claim 5, further comprising:
comparing test data from the one or more tests with a known value for formation rock having the determined lithology; and
using test data that falls within an acceptance criterion for the plotting of data points.

9. The method according to claim 1, wherein the lithology is one selection from a group consisting of sandstone, limestone, and shale.

10. The method according to claim 1, further comprising performing a test on a core sample that represents a depth of the earth formation from which non-validated data points were obtained.

11. The method according to claim 10, further comprising determining a different lithology of the earth formation based on the test.

12. The method according to claim 11, further comprising:
plotting the non-validated data points for a first property versus a second property in a new cross-plot;
plotting a new expected correlation between the first property and the second property on the cross-plot for rock of the new determined lithology;
establishing a new acceptance criterion with respect to the new expected correlation;
determining which of the plotted non-validated data points related to the first property and the second property fall within the acceptance criterion to provide new validated data points related to the first property and the second property; and
inputting the new validated data points related to the first property and the second property into the geomechanical model.

13. A non-transitory computer-readable medium comprising computer-executable instructions for validating earth formation data for input into a geophysical model by implementing a method having steps comprising:
receiving measurement data for a plurality of different properties of the earth formation rock;
determining a lithology of the earth formation using the received measurement data;
plotting data points for a first property versus a second property in a cross-plot, the data points for the first property and the second property being selected from the received measurement data;
plotting an expected correlation between the first property and the second property on the cross-plot for rock of the determined lithology;
establishing an acceptance criterion for validating the data points related to the first property and the second property with respect to the expected correlation; and
determining which of the plotted data points related to the first property and the second property fall within the acceptance criterion to provide validated data points related to the first property and the second property.

14. The non-transitory computer readable medium according to claim 13, the steps further comprising inputting the validated data points related to the first property and the second property into the geomechanical model.

15. The non-transitory computer-readable medium according to claim 13, the steps further comprising indicating to a user one or more data points that are non-validated.

16. The non-transitory computer-readable medium according to claim 15, the steps further comprising:
receiving one or more new data points that replace the one or more non-validated data points;
determining a new lithology of the earth formation using the one or more new data points;
plotting the one or more new data points for the first property versus the second property in a cross-plot;
plotting a new expected correlation between the first property and the second property on the cross-plot for rock of the new determined lithology;
establishing a new acceptance criterion with respect to the new expected correlation; and
determining which of the plotted new data points related to the first property and the second property fall within the new acceptance criterion to provide one or more new validated data points related to the first property and the second property.

17. The non-transitory computer-readable medium according to claim 15, the steps further comprising:
inputting the one or more new validated data points into the geomechanical model.

18. The non-transitory computer readable medium according to claim 13, further comprising:
comparing test data for a test performed on a core sample of the earth formation with a known value for formation rock having the determined lithology; and
using test data that falls within an acceptance criterion for the plotting of data points.
